(19) United States
(12) Patent Application Publication
(10) Pub. No.: US 2002/0117020 A1
(43) Pub. Date: Aug. 29, 2002

(54) Camshaft lubrication system and method of construction thereof

(76) Inventor: Stephen Novak, Anchorage, AK (US)

Correspondence Address: MICHAEL TAVELLA, 2051 BRIGADIER DRIVE, ANCHORAGE, AK, 99507, US

(21) Appl. No.: 09/797,300

(22) Filed: Feb. 28, 2001

(51) Int. Cl. F16H 53/00; F01L 1/047

(52) U.S. Cl. 74/567

(57) ABSTRACT

A camshaft that has a hollow inner chamber and a number of outlet ports. One end of the camshaft is sealed. The other end of the camshaft connects to an engine at a bearing oil gallery. Here, oil is forced into the hollow shaft. A number of holes are drilled around the cam lobes. Two holes are on one side of the shaft and a third is on the opposite side of the shaft. These holes communicate with the hollow interior of the camshaft. As oil is pumped into the shaft, it is forced out of the holes and around the camshaft and the cam lobes. Because each cam lob has these oiling holes, lubrication is provided to all lobes simultaneously. Because the cam lobes are what wears, delivering oil to all lobes simultaneously increases the lobe life significantly.

### CROSS REFERENCE TO RELATED APPLICATIONS

Not Applicable

### STATEMENT REGARDING FEDERALLY SPONSORED RESEARCH AND DEVELOPMENT

Not Applicable

### BACKGROUND OF THE INVENTION

1. Field of the invention

This invention relates to improvements to camshafts and particularly to improvements to the lubrication of camshafts and cam lobes.

2. Description of related art

In four stroke reciprocating engines, the valves (and sometimes-other components) are operated using a camshaft. A typical camshaft has a number of lobes, or cams, that are machines on the main shaft. The lobes ride on cam followers as the camshaft is turned. The cam lobes are typically made of hardened metal. Because these parts make metal to metal contact, their useful life is extended by lubricating them. Lubrication is provided throughout an engine by motor oil that is pumped around the engine under pressure. A typical engine has several oil galleries that deliver oil onto various parts. For many engines, camshafts are lubricated in this manner.

In aircraft engines, particularly a Lycoming, the camshaft is located at the top of the engine. For oil to reach the camshaft, it must be pumped from the oil sump at the bottom of the engine al the way to the top of the engine before the camshaft is lubricated. In some engines, oil for the camshaft comes from oil sloughed off the crankshaft bearings. On cold days, when the oil is thick, the time needed to get the lubrication to the camshaft is considerable. Without oil, the cam shaft lobes become worn. Once the hard coating is worn off, the cam lobes deteriorate quickly. If the cam lobes become worn, the engine loses power. For an airplane in flight, this can be a serious problem and can result in a crash.

Even where camshafts are not located at the tops of engines, lubricating them often involves disbursing oil through a few small galleries as the engine turns. If these galleries are plugged with dirt, the oil coating can be minimal. Lubricating an engine from a few galleries tends to be haphazard and is not the best way to distribute oil onto parts

### BRIEF SUMMARY OF THE INVENTION

The instant invention solves these problems. It is a camshaft that has a hollow inner chamber. One end of the camshaft is sealed. The other end of the camshaft connects to an engine at a bearing oil gallery. Here, oil is forced into the hollow shaft. A number of holes are provided around the cam lobes. Two holes are provided on one side of the shaft and a third is provided on the opposite side of the shaft. These holes communicate with the hollow interior of the camshaft. As oil is pumped into the shaft, it is forced out of the holes and around the camshaft and the cam lobes by centrifugal force. Because each cam has these oiling holes, lubrication is provided to all lobes simultaneously. Because the cam lobes are what wears, providing oil to all lobes simultaneously increases the lobe life significantly. Moreover, because oil is distributed along the length of the shaft, the lubrication of the entire cam shaft area is improved.

### BRIEF DESCRIPTION OF THE DRAWINGS

FIG. 1 is a perspective, partially-cutaway view of a camshaft showing my invention.

FIG. 2 is a partially-cutaway side view of a camshaft showing my invention.

### DETAILED DESCRIPTION OF THE INVENTION

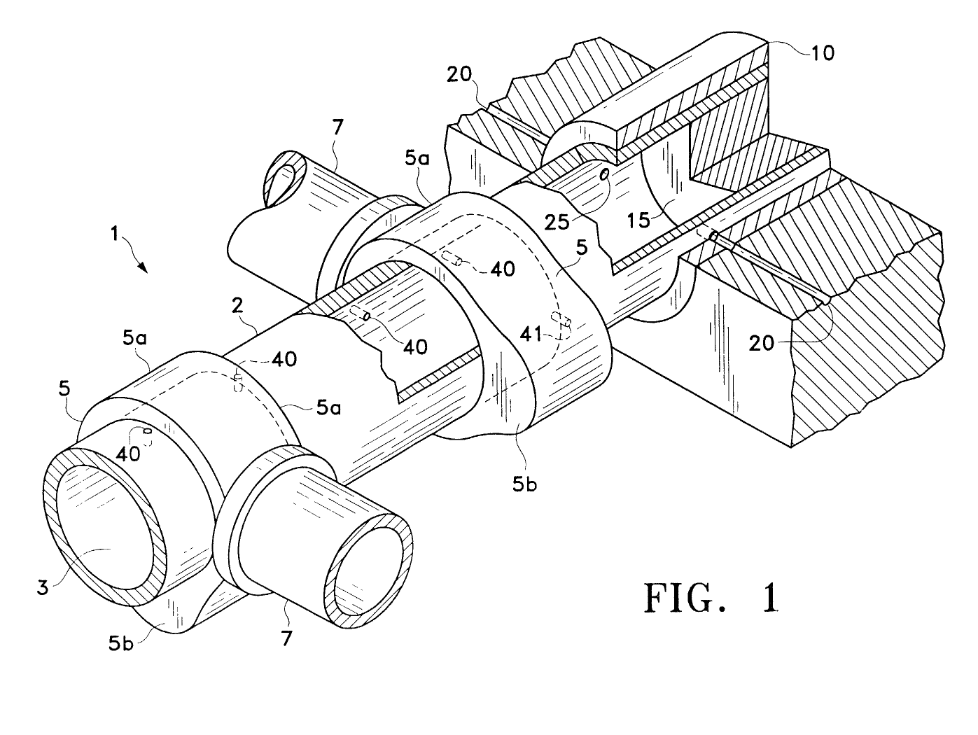

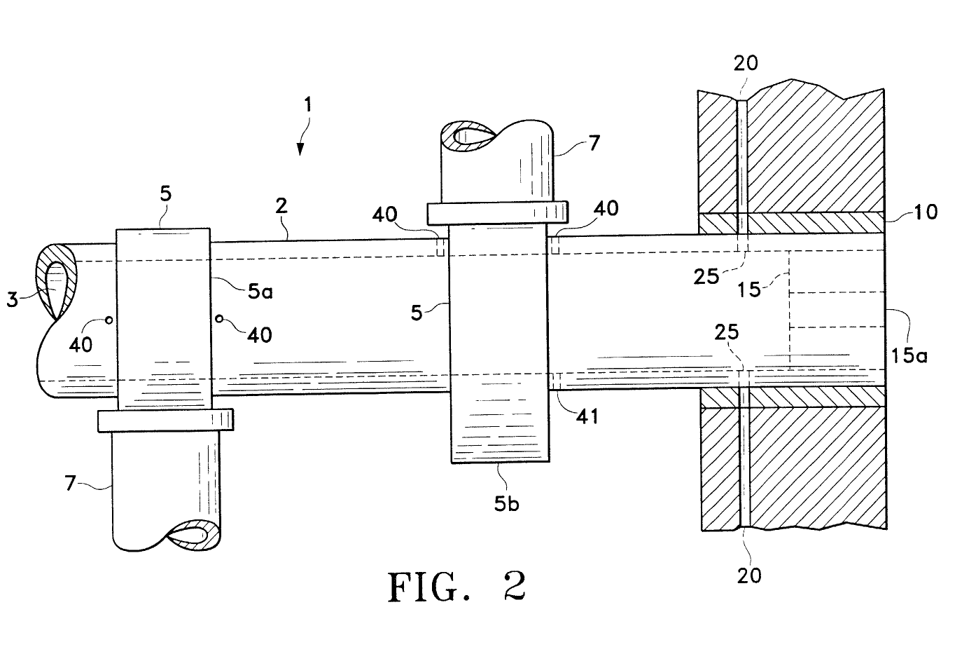

Referring now to FIG. 1, a camshaft 1 is shown. The camshaft 1 has many components. First is the shaft itself. The camshaft 2 has a hollow interior 3 and has a hardened outer surface. The camshaft has a wall thickness as shown. The camshaft 1 has a number of cams 5 machined onto the shaft 2 as shown. FIGS. 1 and 2 show only two cams 5. However, the number of cams is typically more, depending on the size of the engine and number of cylinders. Each ram rubs against a cam follower 7. The cam followers rise and fall with the movement of the cams. If the cam surfaces become worn, the cam followers no longer follow the movement of the cams. If this happens, the engine loses power at best, and can suffer catastrophic failure at worst.

The camshaft 2 is supported by bearings 10. The bearings 10 hold the ends of the camshaft as shown. Note that only one end of the camshaft 2 is shown in the figures. However, a similar bearing supports the other end of the camshaft. A plug 15 is placed in the end of the camshaft 2 as shown. This plug seals the end of the shaft. In the preferred embodiment, the plug 15 is totally sealed. This is shown in FIG. 1. However, the plug can have an open center to permit oil to flow into and out of the shaft. For example, as shown in FIG. 2, the plug 15 has a 1/4-inch hole 15a drilled in its center.

Each of the bearings has oil galleries 20. These ports move oil to the bearing surfaces. The first modification of the camshaft is a pair of ports 25, drilled through the wall of the camshaft. The ports 25 align with the galleries 20 and permit the flow of oil into the camshaft interior 3. In the preferred embodiment, the ports 25 are 9/64 inches or 0.1406 inches. This dimension aligns with the oil passages on the Lycoming engine. A camshaft used in another engine must have its ports drilled to the diameter of the oil passages for that particular engine. As oil flows into the camshaft, it travels down the length of the shaft. As the engine turns, this oil rides against the wall surfaces. The drawing figures show two ports 25. This is adequate for a four-cylinder engine. However, for larger engines, additional ports 25 can be used. For example, three ports, spaced 120° apart can be used, as well as four ports 25 that are spaced 90° apart.

The second part of the invention is a series of outlet ports 40 and 41 that are drilled through the shaft. In the preferred embodiment, the number of holes for each cam is three. Two holes 40 are provided as shown, at the base 5a of the cam 5. In the preferred embodiment, these holes are 0.042 inches in diameter. A single hole 41 is also provided at the lobe end of the cam 5b. In the preferred embodiment, the holes 41 are 0.046 inches in diameter. The holes permit oil to flow from the interior of the camshaft outward and onto the can shaft outer surface. Because of the movement of the camshaft, the oil coming through the ports is thrown over the cam shaft surfaces, including the lobes. Thus, the cam lobes get a continuous bath of oil as the engine operates. This action is like a sprinkler system for the length of the shaft. Moreover, the new lubrication paths deliver oil to other parts of the engine, such as the cylinder walls. More lubrication means a longer life for all these components.

It is important that the holes are positioned exactly as shown. By being positioned adjacent to the lobes, the holes provide the most effective delivery of oil at start-up of the engine. Placing the holes in the lobes themselves is not practical because, in aircraft application, by regulation, the cam lobes must be solid and undisturbed. In non-aircraft applications, the holes in the lobes would significantly shorten the life of the camshaft, which drives up the cost of maintenance to an unacceptable level. This is because drilling through the lobes is difficult because of the hardening of the lobe track surface. Moreover, even if the lobes are drilled, the hole sets up a wear pattern on the lobe that results in premature failure of the camshaft.

The placement of the holes as shown allows the cam tract and the cam followers to be lubed as well as the lobes.

The use of the three-hole placement produces a sprinkler action that also works to lubricate the lower cylinder walls and pistons from above.

This modification works on any internal combustion engine of any configuration that uses a camshaft regardless of the number of cylinders or cylinder position. It is also applicable for overhead cam applications. Moreover, in the overhead cam applications, the valve stem and valve guides are better lubricated.

This configuration produces lubrication where it is needed most-on the cam follower surface. Other designs that may have holes along the camshaft are ineffective because the oil spray mostly misses the cam follower surface.

The placement of the holes as shown produces a simple design that requires less tooling to manufacture. Moreover, any existing camshaft can be easily modified using this design.

The essential factor of this improvement is that it allows oil to get to the cam followers within seconds of engine start up. Without this system it can take up to 10-15 minutes for the oil to reach the camshaft in the engines that have top mounted camshafts. Moreover, the oil remains in the shaft and on the surface of the camshaft after shut down. Thus, a reserve of oil is retained in and on the camshaft, ready for the next engine start.

The system also allows oil to flow and lubricate regardless of engine position or attitude, which makes it ideal for aviation applications.

Once the engine is shutdown, oil in the camshaft remains in the interior of the shaft. This residual amount of oil is available on engine startup to immediately lubricate the camshaft and the lobes. This immediate access to oil prolongs the life of an engine by prolonging the life of the camshaft.

The invention can be used on any camshaft. Of course, camshafts located at the bottom of engines do not suffer from lack of oil as camshafts located at the top of engines. The camshaft shown in the figures is a representative camshaft from a Lycoming engine. In this engine, the camshaft is at the very top of the engine. This often means that the camshaft is not lubricated for a long as several minutes upon engine startup. Using the invention, the camshaft maintains a reservoir of oil inside of the camshaft. This reservoir is available immediately upon the start of the engine. Moreover, oil seeps through the holes provided in the camshaft when the engine is not operating. This seeping maintains a thin coat of oil on the surface of the camshaft. This oil coating is again available immediately on start up.

Consequently, the camshafts stay lubricated, producing a longer life for the engine.

Basically, this invention makes the cam shaft an essential part of the lubrication system of an engine, rather than merely another part that must be lubricated.

The present disclosure should not be construed in any limited sense other than that limited by the scope of the claims having regard to the teachings herein and the prior art being apparent with the preferred form of the invention disclosed herein and which reveals details of structure of a preferred form necessary for a better understanding of the invention and may be subject to change by skilled persons within the scope of the invention without departing from the concept thereof.

claim:

1. A camshaft for use in an internal combustion engine comprising:
a) a shaft having a hollow interior and having a first end and a second end and an outer surface;
b) at least one lobe, formed on said outer surface of said shaft;
c) a means for filling the hollow interior of said shaft with a lubricant; and
d) a means for disbursing the lubricant with said hollow interior to the outer surface of said shaft, said means for disbursing the lubricant including:
i) a pair of holes formed in said shaft and being in alignment with the lobe formed on said shaft and further being positioned immediately adjacent to said lobe such that the lobe is positioned between the pair of holes; and
ii) a single hole, formed in said shaft and being oppositely disposed on said shaft from said pair of holes, said single hole also being positioned immediately adjacent to said lobe.

2. The camshaft of claim 1 wherein the means for filling the hollow interior include at least one entry port, formed in said shaft, whereby said entry port being in communication with an oil source in said internal combustion engine and the hollow interior of said shaft.

3. In a camshaft for an internal combustion engine, wherein said camshaft having an outer surface, a hollow interior, and a plurality of lobes formed on said outer surface, the improvement comprising:
a) a plurality of pairs of holes formed in said shaft, each pair of said plurality of pairs of holes being in alignment with each of said plurality of lobes, formed on said shaft and further being positioned immediately adjacent to each of said plurality of lobes, such that each lobe is positioned between a pair of holes; and
b) a plurality of single holes, formed in said shaft and being oppositely disposed on said shaft from said plurality of pairs of holes, such that a single hole is positioned immediately adjacent to each of said lobes.

4. The method of manufacture of a lubricating cam shaft comprising the steps of:
a) forming a shaft having a hollow interior and having a first end and a second end and an outer surface;
b) forming at least one lobe on said outer surface of said shaft;
c) installing a means for filling the hollow interior of said shaft with a lubricant; and
d) creating a means for disbursing the lubricant with said hollow interior to the outer surface of said shaft, said means for disbursing the lubricant including:
i) a pair of holes formed in said shaft and being in alignment with the lobe formed on said shaft and further being positioned immediately adjacent to said lobe such that the lobe is positioned between the pair of holes; and
ii) a single hole, formed in said shaft and being oppositely disposed on said shaft from said pair of holes, said single hole also being positioned immediately adjacent to said lobe.

5. The method of claim 4 wherein the means for filling the hollow interior includes at least one entry port, formed in said shaft, whereby said entry port being in communication with an oil source in said internal combustion engine and the hollow interior of said shaft.
